(19) United States
(12) Patent Application Publication
(10) Pub. No.: US 2005/0021345 A1
(43) Pub. Date: Jan. 27, 2005

(54) Webcall

(76) Inventors: Carl Jay Rotella, Framingham, MA (US); John DeMarco, Hollywood, FL (US)

Correspondence Address: Carl J Rotella, 52 Delmar Ave, Framingham, MA, 01701, US

(21) Appl. No.: 10/287,830

(22) Filed: May 5, 2003

(51) Int. Cl. G06F 17/60

(52) U.S. Cl. 705/1

(57) ABSTRACT

Webcall International dialing product. Webcall will originate a call in the United State from a user on the Internet using Browsers and will call the number select by the user. After the user is connecting the product will originate a second call to select contact in and connect the two parties. At the end of the call the system will automatically call the next contact on selected list or dial a new number directly.

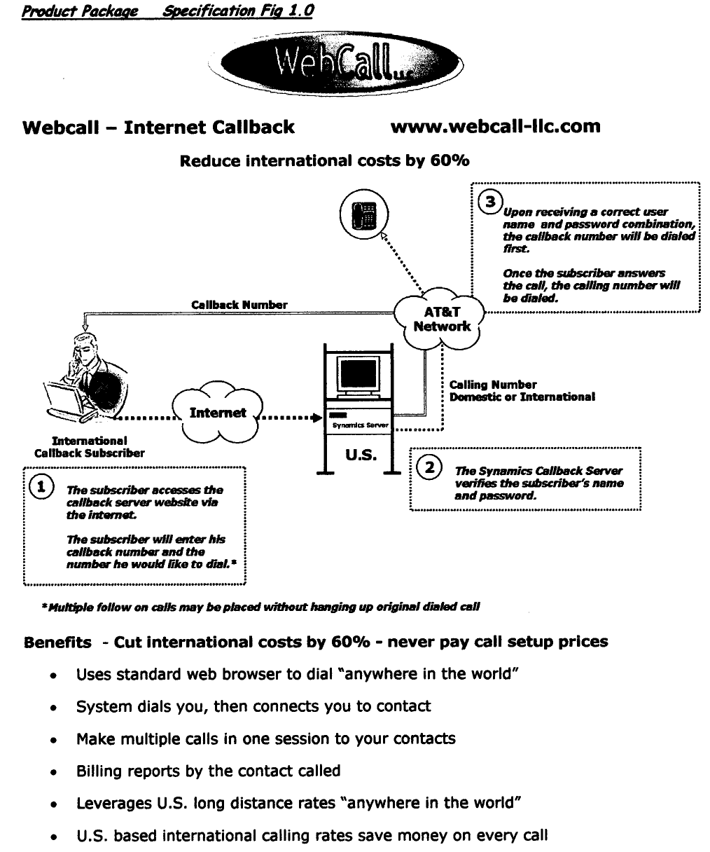

### 1. INTRODUCTION

1.1 Document Objectives

This document presents the Product Requirements Specification for the initial phase of the Webcall product. It describes at a high level the operation of the application, proposes a conceptual solution approach, and provides more in-depth detail around specific requirements for the application.

These product requirements will be assessed by Professional Services and Engineering for feasibility (both development effort and technical feasibility), then serve as the basis for the development of the solution Functional Specifications, software, test cases, etc.

In addition, this document provides some limited market analysis and background information to assist Professional Services and Engineering in specification, design and development of the product and underlying platform.

1.2 Project Goal

The objective of the project is to deliver a production quality application which will allow our customer to offer Web-based call back services to their international customer in several Caribbean and Central American countries.

1.3 Project Scope

This project will encompass the basic capabilities of the following key areas of functionality:
Web Interface for following functions:
   Subscriber, Organization and System Administration
   Placing calls
Provisioning Interface accessible via remote dial-up/telnet session (System Administrator access only)
Telephone Interface for subscribers
Call Detail Records

Future phases and additional features beyond those specified herein will be considered separate projects, and will be sponsored by their own business cases and project justification. These include additional language and capability.

1.4 Risks

It is assumed that Webcall will run on the TAS 8.0 platform, therefore the availability of the platform presets a risk.

1.5 Assumptions and Dependencies

It is assumed that the application will execute on the TAS 8.0 platform.

The following dependencies have been identified in relation to the development of Webcall:
Availability of the TAS 8.0 platform
   1.6 Requirements Classification

The detailed requirements are classified according to the urgency with that they must be included in the application The classification categories are:
Mandatory (M)—The application must conform to the requirement.
Highly Desirable (HD)—The requirement is very important to the application in terms of its competitiveness and/or completes. Effort should be made to include this requirement in the finished product.
Desirable (D)—The feature would be beneficial to users of the application and would assist in the competitiveness and salability of the product.
Future (F)—Indication that this feature will be required in a future version of the application. Largely for information purposes and steps should be taken in the current release to facilitate later addition of the feature.
   2. Background
   2.1 Business Objective

The Business Objective for Webcall is to provide WebCall with and international callback application that will allow their subscribers to request a call set up to originate both calling legs from the U.S.

2.2 Markets

WebCall is a new division of Executive Assistant, a small Service Provider based in Miami, Fla. Its customers will be international individual end users and small businesses.

Usage volume estimates are unavailable at the current time.

2.3 Conceptual Product Description

The diagram below shows a high level conceptual view of Webcall and its environment.

3. Webcall System Users

3.1 Introduction

The primary Users of Webcall will be international small businesses employees.

3.2 Subscriber

A Subscriber is classified as the primary user of the application. A Subscriber has the ability to initiate calls and preform personal account maintenance via a web interface.

3.3 External Caller

A secondary user of the application is an external caller. No special features are required for the subscriber's called party The subscriber's called party's experience will be the same as if the subscriber dialed the number directly.

3.4 Organization Administrator

An Organization Administrator is responsible for the management of all aspects of the application for a company or a dependant with subscribers using the application. An Organization Ad at is able to create, delete, modify and suspend subscriber accounts.

3.5 System Administrator

The System Administrator is responsible for the management of the underlying platform and physical and logical system resources. This includes installing, staring, and stopping the execution of the application. The System Administrator has the ability to perform all Organization Administrator functions.

3.6 Webcall IIc Support

A Webcall IIc Support User will have access to perform maintenance functions on the system. In addition to overall System Administrator functionality, Webcall lic Support may require functions for license key management, software installation and configuration options, and perhaps the exercise of additional logging or other debugging tools.

3.7 External Operational Support Systems

Interfaces for external OSS are required to be implemented for the following functions:
Monitoring health of the application and underlying hardware platform
Monitoring load on the application and platform
Extracting billing records

Interfaces may be may be asynchronous ASCII, SNMP, FTP or other.

4. Interface Requirements

4.1 User Interfaces

Three mechanisms for Human interface will be required for the Webcall, including the following:
WEB Interface (GUI)—Used by Subscribers, and Organization and System Administrators, and provides the following functionality:
   Subscriber Administration
   Account Balance Administration
   Call Set Up
   Ability to Pie Calls
   Organization Administration
   System Administration
   Billing Administration
Telephone Interface (TUI)—Used by Subscribers to instruct Webcall to perform system functions.
Menu Driven Provisioning Interface (MDI)—Used by System Administrator for provisioning of subscriber accounts via a remote dial-in/telnet session.

The following describes some of the physical and high level features of the user interfaces, with the functional aspects of these described in the following section.

| Feature | | | |
|---|---|---|---|
| ID | Feature name | Description | M/HD/D |
| 4.1.1 | Subscriber Access | | |
| 4.1.1.1 | Min and Maximum | The System Administrator | M |
| | Password Length | will have set a minimum | |
| | | (6) and maximum length | |
| | | (14) of password to which | |
| | | the User must adhere. | |
| 4.1.1.2 | Encrypted storage | All passwords must be | M |
| | of passwords | stored in encrypted | |
| | | fashion. Administrators | |
| | | may NOT read them | |
| | | in plaintext. | |
| 4.1.2 | Subscriber | | |
| | Interface | | |
| | Company branding | Purchaser must be able | |
| | and Customization | to customize the login | |
| | | screen with their logo | |
| | | and brief instructions. | |
| 4.1.2.1 | HTTP 1.1 | The system must support | M |
| | | HTTP 1.1 over TCP/IP | |
| | | for the web access. | |
| 4.1.2..2 | HTTPS | As an option for deployment, | M |
| | | the system must support | |
| | | HTTPS (secure) over TCP/IP | |
| | | for the web access. | |
| 4.1.2..3 | SSL Option | Purchaser must have the | M |
| | | option of deploying | |
| | | the application using a | |
| | | secure web server, Secure | |
| | | Sockets Layer and HTTPS. | |
| 4.1.3 | Language Support | | |
| 4.1.3.1 | Initial support | The initial release of | M |
| | for American | Webcall must support the | |
| | English | English language (American | |
| | | dialect). | |
| | | Additional languages for | F |
| | | prompts and web interface | |
| | | are a future requirement. | |

4.2 External System Interfaces

Requirements Related to External System interfaces

| Feature | | | |
|---|---|---|---|
| ID | Feature name | Description | M/HD/D |
| 4.2.1 | Billing | | |
| | Requirements | | |
| 4.2.1.1 | Integration with | The Webcall application | M |
| | External Billing | is required to integrate | |
| | System | with the Active | |
| | | Telemanage Corp Billing | |
| | | System. | |
| | | (www.activetel.com) | |
| 4.2.1.2 | CDRs Pull | The customer will have | M |
| | | the ability to pull CDR | |
| | | at X number of intervals | |
| | | per 24 hours. | |
| 4.2.1.3 | CDR Storage | CDRs should be stored | M |
| | | for 7 days, and | |
| | | automatically deleted | |
| | | on day 8. | |
| 4.2.1.3 | CDR Back Up | Back up CDRs should be | M |
| | Files | abled to stored on | |
| | | both a CD and or | |
| | | network server | |
| 4.2.2 | Rating Interface | | |
| 4.2.2.1 | Integration with | The Webcall application | M |
| | 3^{rd} Party Rating | is required to integrate | |
| | System | with the Active Telemanage | |
| | | Corp Billing System to | |
| | | provide rating functionality. | |
| | | Please refer to section | |
| | | 5.6 for more details | |

5. Functional Requirements
5.1 Introduction

This section describes the functional feature requirements of Webcall. The capabilities are defined against the class of user who will require the feature.

5.2 Subscriber Functions

The following table defines the functional features required for the Subscriber interface in the Webcall application.

| Feature | | | |
|---|---|---|---|
| ID | Feature name | Description | M/HD/D |
| 5.2.1 | Subscriber | | |
| | Login | | |
| 5.2.1.1 | Login | Secure login to the system | M |
| | | requiring a user ID | |
| | | and password. | |
| 5.2.1.2 | Reset Password | User may initiate the reset | M |
| | | and sending of a | |
| | | temporary new password | |
| | | to the user's email if | |
| | | it has been forgotten. | |
| 5.2.1.3 | Logout | Subscriber may logout of | M |
| | | the application | |
| | | without impacting the call. | |
| 5.2.2 | Subscriber | | |
| | Administration | | |
| 5.2.2.1 | Change Password | The ability to change a | M |
| | | password used over the | |
| | | GUI. | |
| 5.2.2.2 | Modify Subscriber | Subscriber can modify | M |
| | Account | their callback numbers | |
| | | and callback number | |
| | | labels. | |
| 5.2.3 | Place Calls | | |
| 5.2.3.1 | Initiate Call(s) | Subscriber can initiate a | M |
| | via Web Interface | call for the selected | |
| | | destination. | |
| 5.2.3.2 | Subscriber Accept | The system will dial the | M |
| | Call from System | subscriber's callback | |
| | | number, before initiating | |
| | | the call to the | |
| | | destination. The subscriber | |
| | | MUST accept the call. | |
| | | (Accept Call DTMF = 2) | |
| 5.2.3.3 | Prompt at | Upon completion of a call, | M |
| | completion of call | the subscriber is prompted | |
| | | via the TUI if they wish | |
| | | to terminate the call, place | |
| | | the next call, or skip over | |
| | | number. (Terminate Call | |
| | | DTMF = 8, Next Call | |
| | | DTMF = 6, Skip Number | |
| | | DTMF = 7) | |
| 5.2.3.4 | Initiate Call(s) | Upon successful completion | M |
| | via DTMF | of all web entered numbers, | |
| | | the subscriber is prompted | |
| | | via the TUI if they wish to | |
| | | terminate the call or place | |
| | | a call via DTMF. (Terminate | |
| | | Call DTMF = 8, | |
| | | Place Call via DTMF = 3) | |
| 5.2.3.5 | Re-attempt | If a call should not be | M |
| | incomplete calls | completed successfully, | |
| | | i.e. busy signal, the system | |
| | | will ask the subscriber if | |
| | | they would like to reattempt | |
| | | to connect to the incomplete | |
| | | calls. (Re-attempt = 9) | |
| 5.2.3.6 | Return to Main | If the subscriber receives a | M |
| | Menu | ring no answer or voicemail, | |
| | | they can enter a combination | |
| | | of DTMFs to be returned to | |
| | | the main menu. | |
| | | (Cancel Call = *22) | |
| 5.2.3.7 | Return on Busy | System informs Subscriber | M |
| | | line is busy, and | |
| | | returns to main menu. | |
| 5.2.3.8 | Balance Update | After the completion of each | M |
| | | leg of a call, if the | |
| | | subscriber refreshes his/her | |
| | | screen the balance | |
| | | field will be updated. | |
| 5.2.3.9 | End on | The call ends when the | M |
| | Subscriber exit | Subscriber hangs up. | |

5.3 Organization Administrator Functions

The following outlines the feature requirements for the Organization Administrator (OA). These Administrators will access Webcall using the Web interface.

| Feature | | | |
|---|---|---|---|
| ID | Feature name | Description | M/HD/D |
| 5.3.1 | Organization | | |
| | Admin Login | | |
| 5.3.1.1 | Login | Secure login to the system | M |
| | | requiring a User ID and | |
| | | password. The system will | |
| | | NOT allow the users to save | |
| | | their user id and password. | |
| 5.3.1.2 | Change Password | The ability to change a | M |
| | | password, where a | |
| | | password is used to | |
| | | access the GUI. | |
| 5.3.1.4 | Logout | Subscriber may logout | M |
| | | of the GUI. | |
| 5.3.2 | Subscriber Account | | |
| | Management | | |
| 5.3.2.1 | Create Subscriber | Ability to create a | M |
| | Account | subscriber account. | |
| 5.3.2.2 | Modify Subscriber | OA can modify the | M |
| | Account | subscriber's account | |
| | | information. | |
| 5.3.2.3 | Delete Subscriber | OA may delete the | M |
| | Account | subscriber account. | |
| 5.3.2.4 | Suspend Subscriber | OA may suspend the | M |
| | Account | subscriber account, | |
| | | preventing them from | |
| | | logging into the system | |
| | | but leaving the data in | |
| | | the system. | |
| 5.3.2.5 | Resume Subscriber | OA may remove the | M |
| | Account | suspension of access to | |
| | | the subscriber account. | |
| 5.3.2.6 | Create Account | The system must have a | M |
| | Balance | field for the OA to be | |
| | | able to enter a balance | |
| | | for each subscriber | |
| 5.3.2.7 | Modify Account | The ability to adjust the | M |
| | Balance | subscriber balance | |
| 5.3.3 | Management | | |
| | Reports | | |
| 5.3.3.1 | View Call Log | OA may view a log of all | M |
| | | completed calls for | |
| | | the organization. | |
| 5.3.3.2 | View Subscriber | OA may view a list of all | M |
| | Account Balances | subscribers and | |
| | | outstanding balances | |
| 5.3.3.3 | View Negative | OA may view a list of all | M |
| | Balance Accounts | subscribers who are | |
| | | carrying a negative balance. | |

5.4 System Administrator Functions

There are two major categories of functionality for the System Administrators.
Managing system health
Managing Organization and their administrators

The following section outlines requirements for managing Organizations and Administrators.

Certain functions must be available over the Web GUI, while the majority may only be required over a Menu Driven Interface (MDI). The following also assumes the System Administrator has access to general system functions such as DBMS back-up utilities, FTP and file copy, process start/top, etc.

| Feature | | | |
|---|---|---|---|
| ID | Feature name | Description | M/HD/D |
| 5.4.1 | System Admin | | |
| | Access | | |
| 5.4.1.1 | Login | Secure login to the system | M |
| | | requiring a User | |
| | | ID and password. | |
| 5.4.1.2 | Change | The ability to change a | M |
| | Password | password, where a | |
| | | password is used to | |
| | | access the Web or MDI. | |
| 5.4.1.3 | Modify | Change Password or other | M |
| | Profile | Administrator | |
| | | profile information. | |
| 5.4.1.4 | Logout | Administrator may logout | M |
| | | of the Web GUI or MDI. | |
| 5.4.2 | Organization | | |
| | Management | | |
| 5.4.2.1 | Create | Ability to create an | M |
| | Organization | organization. | |
| 5.4.2.2 | Modify | Ability to modify an | M |
| | Organization | organization definition. | |
| 5.4.2.3 | Delete | Ability to delete an | M |
| | Organization | organization. | |
| 5.4.2.4 | Suspend | Ability to suspend an | M |
| | Organization | organization and all | |
| | | of its subscribers. | |
| 5.4.2.5 | Create | Ability to create an | M |
| | Organization | Account for an OA. | |
| | Administrator | | |
| 5.4.2.6 | Modify | Ability to modify an | M |
| | Organization | Account for an OA. | |
| | Administrator | | |
| 5.4.2.7 | Delete | Ability to delete an | M |
| | Organization | Account for an OA. | |
| | Administrator | | |
| 5.4.2.8 | Suspend | Ability to suspend an | M |
| | Organization | account for an OA. | |
| | Administrator | | |
| 5.4.3 | System | | |
| | Management | | |
| | Reports | | |
| 5.4.3.1 | View Call | A log of total number of | |
| | Totals | call legs, and number of | |
| | | minutes accumulated for | |
| | | the subscriber and | |
| | | destination legs. | |
| 5.4.3.2 | View Port | A plot of the past Port | M |
| | Utilization - | usage statistics | |
| | Historic | | |
| 5.4.3.3 | View Call | SA may view the current | M |
| | Usage | calls in progress. | |
| 5.4.3.4 | View Call | SA may view a log of all | M |
| | Log | completed calls | |
| | | for a specified period. | |

5.5 Rating Functions

The following table defines the functional is required for the rating all calls initiated via the Webcall application.

| Feature | | | |
|---|---|---|---|
| ID | Feature name | Description | M/HD/D |
| 5.5.1 | Web Interface | | |
| 5.5.1.1 | Input Subscriber | The system must provide an | M |
| | Balance | account balance field for | |
| | | administrators to input a | |
| | | subscriber's balance | |
| 5.5.1.1 | Subscriber | The system must provide an | M |
| | Balance | account balance field for | |
| | | subscribers to clearly see | |
| | | their account balance. This | |
| | | field may only be updated by | |
| | | the System Administrator. | |
| 5.5.2 | Balance Updates | | |
| 5.5.2.1 | Subscriber balance | The system should update the | M |
| | updates | subscriber balance after each | |
| | | B leg is completed, and | |
| | | when the final Leg A is | |
| | | terminated. | |
| | | If the subscriber's balance is | |
| | | above $7.00, he may place the | |
| | | next call. | |
| | | If the subscriber's balance is | |
| | | below $7.00, please see | |
| | | section 5.6.3.3 | |
| 5.5.3 | Prompting- | | |
| | Balance Updates | | |
| 5.5.3.1 | Update Call Balance | The system must play the | M |
| | Prompt | subscriber a two prompts | |
| | | letting the subscriber know | |
| | | his balance is being updated, | |
| | | then state the new balance. | |
| | | “Please hold while your | |
| | | balance is being | |
| | | updated.” | |
| 5.5.3.2 | Below Minimum | After the completion of each | M |
| | Balance Prompt | leg B, the system will update | |
| | | the subscriber's balance. If | |
| | | the balance is less than $7.00, | |
| | | then the subscriber can not | |
| | | place the next call. If the | |
| | | scenario should occur, the | |
| | | system should play a prompt | |
| | | informing the subscriber and | |
| | | then terminate Leg A. | |
| | | “You current balance is | |
| | | below the minimum required | |
| | | balance, please contact your | |
| | | system administrator.” | |

Please Note: The system does not update the subscriber's balance until a call is completed, therefore there is a potential for a subscriber to obtain a negative balance. Depending on the length of the call will determine amount of the negative balance. Limited the total talk time per a single session, may reduce the risk of large negative balances.

| Feature ID | Feature name | Description | M/HD/D |
|---|---|---|---|
| 5.6.1 | Dialing Restriction | | |
| 5.6.1.1 | International | The system should support | M |
| | Dialing | the international | |
| | | dialing standard | |
| | | (15 digits). | |

6. N n-Functional Requirements
6.1 Packaging Requirements

Webcall will be packaged and delivered on the TAS platform. As such there are no application specific packaging requirements.

6.2 Performance Requirements

The following outlines the performance requirements for the Webcall product.

| Feature ID | Feature name | Description | M/HD/D |
|---|---|---|---|
| 6.2.1 | Performance | | |
| | Requirements | | |
| 6.2.1.1 | TUI Response | The TUI must provide a | M |
| | | response time of <2 | |
| | | sec 95% of the time in | |
| | | the busy hour. (time | |
| | | measured from DTMF | |
| | | input to start of | |
| | | response message or | |
| | | next prompt). | |
| 6.2.1.2 | Web GUI | The Web GUI must | |
| | Response | provide an application | |
| | | response time of <5 sec. | |
| | | 95% of the time in | |
| | | the busy hour | |
| 6.2.1.3 | MDI Response | The MDI must provide | M |
| | | a response time of <3 | |
| | | sec 95% of the time | |
| | | in the busy hour | |

6.3 Installation Requirements

The following outlines the installation requirements for the Webcall product.

| Feature ID | Feature name | Description | M/HD/D |
|---|---|---|---|
| 6.3.1 | Installation | | |
| | requirements | | |
| 6.3.1.1 | Separate System | The basic system hardware | M |
| | and Application | and operating software | |
| | Installs | must be able to be | |
| | | installed prior to | |
| | | the Webcall application | |
| 6.3.1.2 | Scripted | All Webcall installation | M |
| | Application | should be accomplished | |
| | installation | via automated scripts. | |
| 6.3.1.3 | Application | All application software | M |
| | Software | should be installed | |
| | Installation | from CD ROM or Network | |

6.4 Maintenance Requirements

The following outlines the maintenance requirements for the Webcall product.

| Feature ID | Feature name | Description | M/HD/D |
|---|---|---|---|
| 6.4.1 | Maintenance | | |
| | requirements | | |
| 6.4.1.1 | Software | Software back ups may | M |
| | Back Ups | be backed up to | |
| | | network or CD ROM | |
| 6.4.1.2 | BackUp and | System restore process | M |
| | Restore | should not EXCEED 2 | |
| | | hours | |
| 6.4.1.3 | Hardware | That ability to manage | M |
| | Test | T1, network control, | |
| | | network host table, | |
| | | and ARP should be | |
| | | available, at a minimum, | |
| | | via a command line | |
| | | interface. | |

6.5 Documentation Requirements

The following documentation is required for Webcall.

| Feature | | | |
|---|---|---|---|
| ID | Feature name | Description | M/HD/D |
| 6.5.1 | User Documentation | | |
| 6.5.1.1 | Subscriber Quick | One page tool that allows | M |
| | Reference Guide | the subscriber to quickly | |
| | | navigate the through Webcall | |
| 6.5.1.2 | User Guide - | Detailed document outlining | HD |
| | Organization | how to add, modify, delete | |
| | Admin | subscribers; create reports; | |
| | | etc. | |
| 6.5.2 | System | Detailed document outlining | M |
| | Administrator | how to manage system health | |
| | Guides | and perform overall system | |
| | | administration. | |
| 6.5.2.1 | Installation | One page tri-fold card that | M |
| | Card | explains how to install the | |
| | | system. (Customer will | |
| | | provide sample document) | |

6.6 Training Requirements

There are no Training requirements for the Webcall initial release.

7. Future Enhancements

Future enhancements will be identified at a later date under a separate project.

| Feature | | | |
|---|---|---|---|
| ID | Feature name | Description | M/HD/D |
| 7.1 | Language | | |
| 7.1.1 | Spanish Language - | The web interface will | M |
| | Web Interface | need to be translated | |
| | | to Spanish | |
| 7.1.2 | Spanish Language - | The prompts will need | M |
| | IVR | to be translated to | |
| | | Spanish | |
| 7.2 | Conferencing | | |
| 7.2.1 | Web initiated | The application will be | M |
| | Conferencing | required to initiate a | |
| | | multiparty from a web | |
| | | initiated call. | |

1. this is cost effective way to connect two people and anywhere in the world. Direct originating calls from the US on US rates to users and contacts by means of selection over the Internet. As outlined in the SPEC sent on Jan. 30^{th} I claim to have the product design, tested, and ready for
Use to support this call model.
